(19) United States
(12) Patent Application Publication
(10) Pub. No.: US 2015/0138135 A1
(43) Pub. Date: May 21, 2015

(54) PROTECTIVE CASE FOR ELECTRONIC DEVICE, INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Miao Gan, Beijing (CN)

(73) Assignees: Lenovo (Beijing) Co., Ltd., Beijing (CN); Beijing Lenovo Software Ltd., Beijing (CN)

(21) Appl. No.: 14/221,496

(22) Filed: Mar. 21, 2014

(30) Foreign Application Priority Data
Nov. 18, 2013 (CN) 201310576636.6

(51) Int. Cl. G06F 1/16; G06F 3/044

(52) U.S. Cl. CPC G06F 1/1692; G06F 3/044; G06F 2200/1633
USPC 345/174

(57) ABSTRACT

A protective case for an electronic device, an information processing method and an electronic device are disclosed, for solving the technical problem that it takes long time for the electronic device to receive a touch operation in a case that the electronic device is protected by the protective case for the electronic device. The protective case for the electronic device includes: a housing including a first region and a second region different from the first region; and a conductive material provided at a bottom portion of the second region. In a case that the electronic device is protected by the protective case for the electronic device, if a first touch operation is performed in the second region, the electronic device obtains, via the conductive material, a second touch operation corresponding to the first touch operation, to execute a control instruction corresponding to the second touch operation.

### CROSS REFERENCES OF RELATED APPLICATIONS

The present application claims the priority to Chinese Patent Application No. 201310576636.6, entitled “PROTECTIVE CASE FOR ELECTRONIC DEVICE, INFORMATION PROCESSING METHOD AND ELECTRONIC DEVICE”, filed on Nov. 18, 2013 with the State Intellectual Property Office of People's Republic of China, which is incorporated herein by reference in its entirety.

### FIELD

The present disclosure relates to electronic technologies, and in particular, to a protective case for an electronic device, an information processing method and an electronic device.

### BACKGROUND

With the rapid development of electronic techniques, functions of various mobile devices become more and more plentiful and humanized, and accordingly, the user experience in the usage of the mobile devices gets better. Taking mobile phone as an example, the intelligent mobile phone nowadays has been developed into a small computer, which has not only large storage for installing various software, but also various functions turning more and more delicate and humanized.

As the function of the mobile device becomes more and more powerful, a screen of the mobile device gets bigger and bigger. To protect the screen of the mobile device, it is generally necessary to provide the mobile device with a protective case, which can not only protect but also embellish the mobile device.

The inventor of the disclosure finds that at least the following technical problems.

Conventionally, if the mobile device is protected by the protective case for the electronic device, a user should uncover the protective case for the electronic device if he wants to operate the mobile device, such as answering a call, hanging up a call or playing music. Therefore, a technical problem of long time consumption is caused, the operation is not convenient, and accordingly, the user experience is decreased.

### SUMMARY

A protective case for an electronic device, an information processing method and an electronic device are provided according to embodiments of the disclosure, for solving the existing technical problem that it takes long time for an electronic device to receive a touch operation in the case that the electronic device is protected by a protective case for the electronic device.

In a first aspect of the disclosure, a protective case for an electronic device is provided. The protective case for the electronic device includes: a housing including a first region and a second region different from the first region; and a conductive material provided at a bottom portion of the second region. In a case that the electronic device is protected by the protective case for the electronic device, if a first touch operation is performed in the second region, the electronic device obtains a second touch operation corresponding to the first touch operation via the conductive material, to execute a control instruction corresponding to the touch operation.

In conjunction with the first aspect, in a first possible approach of implementation, the first region has a thickness greater than that of the second region. Hence, in the case that no external force is applied in the second region, the conductive material is not in touch with the electronic device.

In conjunction with the first aspect, in a second possible approach of implementation, the housing further includes a third region different from either the first region or the second region, the third region is made from a transparent material, and faces a display region of a display unit in the case that the electronic device is protected by the protective case for the electronic device.

In conjunction with the first aspect, in a third possible approach of implementation, a magnet is provided in the protective case for the electronic device. The electronic device may detect, through the magnet, whether the electronic device is protected by the protective case for the electronic device.

In a second aspect of the disclosure, an information processing method applied to an electronic device is provided. The information processing method includes: detecting whether the electronic device is protected by a protective case for the electronic device, where the protective case for the electronic device includes a first region and a second region, and a conductive material is provided at a bottom portion of the second region; and adjusting a display interface of the electronic device from a first display interface to a second display interface in the case that the electronic device is protected by the protective case for the electronic device, where the second display interface obtains, via the conductive material, a touch operation performed in the second region, to execute by the electronic device a control instruction corresponding to the touch operation.

In conjunction with the second aspect, in a first possible approach of implementation, if a magnet is provided the electronic device protective case, detecting whether the electronic device is protected by the protective case for the electronic device includes: detecting a Hall current value with a Hall sensor provided in the electronic device; determining whether the Hall current value is greater than a preset current value, and determining that the electronic device is protected by the protective case for the electronic device if the Hall current value is greater than the preset current value.

In conjunction with the second aspect or the first possible approach of implementation of the second aspect, adjusting the display interface of the electronic device from the first display interface to the second display interface includes: calling the second display interface preset in the electronic device, and replacing the first display interface with the second display interface. Alternatively, adjusting the display interface of the electronic device from the first display interface to the second display interface includes: determining, on the electronic device, a fourth region corresponding to the second region; and adjusting the display interface to the second display interface based on the fourth region.

In conjunction with the second aspect or the first possible approach of implementation of the second aspect, the second display interface is the display interface with an operation button facing the second region; and/or in the case that the protective case for the electronic device includes a third region made from a transparent material, the second display interface is the display interface with display contents facing the third region.

In a third aspect of the disclosure, an electronic device is provided. The electronic device includes: a detecting module configured to detect whether the electronic device is protected by a protective case for the electronic device, where the protective case for the electronic device includes a first region and a second region, and a conductive material is provided at a bottom portion of the second region; and an adjusting module configured to adjust a display interface of the electronic device from a first display interface to a second display interface in the case that the electronic device is protected by the protective case for the electronic device, where the second display interface obtains, via the conductive material, a touch operation performed in the second region, to execute by the electronic device a control instruction corresponding to the touch operation.

In conjunction with the third aspect, in a first possible approach of implementation, if a magnet is provided in the protective case for the electronic device, the detecting module includes: a detecting unit configured to detect a Hall current value with a Hall sensor provided in the electronic device; and a determining unit configured to determine whether the Hall current value is greater than a preset current value, and to determine that the electronic device is protected by the protective case for the electronic device if the Hall current value is greater than the preset current value.

In conjunction with the third aspect or the first possible approach of implementation of the third aspect, the adjusting module is configured to: call the second display interface preset in the electronic device, and replace the first display interface with the second display interface. Alternatively, the adjusting module includes: a determining unit configured to determine, on the electronic device, a fourth region corresponding to the second region; and an adjusting unit configured to adjust the display interface to the second display interface based on the fourth region.

In conjunction with the third aspect or the first possible approach of implementation of the third aspect, the second display interface is the display interface with an operation button facing the second region; and/or in the case that the protective case for the electronic device includes a third region made from a transparent material, the second display interface is the display interface with display contents facing the third region.

The disclosure has the following advantages.

According to the embodiments of the disclosure, the housing of the electronic device protective case includes the first region and the second region, and the conductive material is provided at a bottom portion of the second region. Therefore, in a case that the electronic device is protected by the protective case for the electronic device, if a touch operation is performed in the second region, the touch operation may be transferred to the electronic device via the conductive material, to execute by the electronic device the control instruction corresponding to the touch operation. That is to say, the electronic device may be operated by performing the touch operation on the protective case for the electronic device without uncovering the protective case for the electronic device. Hence, the technical effect of reducing the time required for the electronic device to receive the touch operation in a case that the electronic device is protected by the protective case for the electronic device is achieved, the operation is more convenient, and accordingly, the user experience is improved.

### BRIEF DESCRIPTION OF THE DRAWINGS

FIG. 1 is a structural diagram of a protective case for an electronic device according to an embodiment of the disclosure;

FIG. 2a is a schematic diagram reflecting that a second region of a protective case for an electronic device according to an embodiment of the disclosure is not in touch with the electronic device;

FIG. 2b is a schematic diagram reflecting that a second region of a protective case for an electronic device according to an embodiment of the disclosure is in touch with the electronic device;

FIG. 3 is a structural diagram of a protective case for an electronic device according to an embodiment of the disclosure, where the protective case includes a third region;

FIG. 4 is a flow chart of an information processing method according to an embodiment of the disclosure;

FIG. 5 is a flow chart of determining a second display interface in an information processing method according to an embodiment of the disclosure; and

FIG. 6 is a structural diagram of an electronic device according to an embodiment of the disclosure.

### DETAILED DESCRIPTION OF THE EMBODIMENTS

A protective case for an electronic device, an information processing method and an electronic device are provided in the disclosure, for solving the technical problem that it takes long time for an electronic device to receive a touch operation in the case that the electronic device is protected by a protective case for the electronic device.

To solve the above technical problem, general ideas of a technical solution according to embodiments of the disclosure are as follows.

A protective case for an electronic device is provided. The protective case for the electronic device includes: a housing including a first region and a second region different from the first region; and a conductive material provided at a bottom portion of the second region. In the case that the electronic device is protected by the protective case for the electronic device, if a first touch operation is performed in the second region, the electronic device may receive a second touch operation corresponding to the first touch operation via the conductive material, and the electronic device may further execute a control instruction corresponding to the second touch operation.

In the above solution, the electronic device may be operated by performing the touch operation on the protective case for the electronic device without uncovering the protective case for the electronic device. Therefore, a technical effect of reducing the time required for the electronic device to receive the touch operation in the case that the electronic device is protected by the protective case for the electronic device is achieved, the operation is more convenient, and accordingly, the user experience is improved.

To understand the above technical solution better, the technical solution of the disclosure is described in detail hereinafter in conjunction with drawings and the embodiments. It should be understood that the embodiments of the disclosure and specific features according to the embodiments are intended to illustrate rather than to limit the technical solution of the disclosure. The embodiments of the disclosure and the specific features according to the embodiments may be combined if they do not conflict.

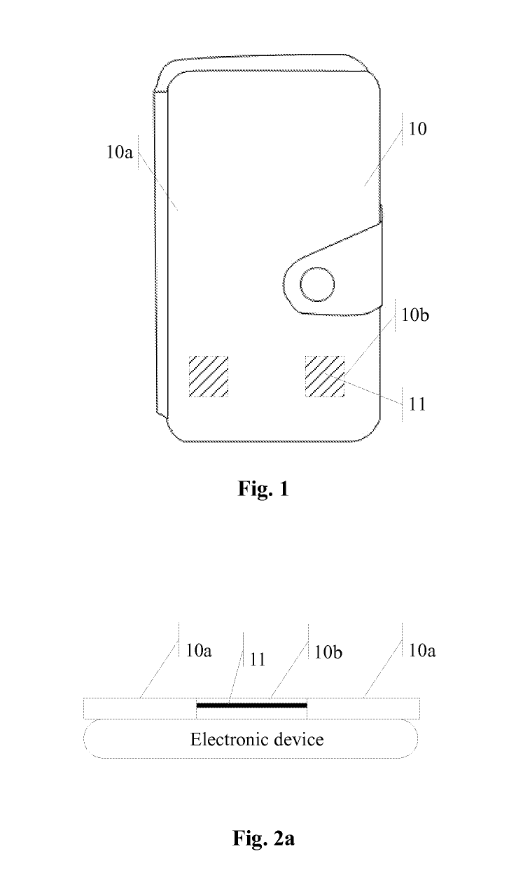

In a first aspect, a protective case for an electronic device is provided according to an embodiment of the disclosure. Referring to FIG. 1, the protective case for the electronic device includes a housing 10 and a conductive material 11.

The housing 10 includes a first region 10a and a second region 10b different from the first region 10a. The housing 10 may be made from various materials such as cortex, crystal, silica gel, etc., which is not limited in the disclosure.

The conductive material 11 is provided at a bottom portion of the second region 10b. The conductive material 11 may be, for example, conductive rubber, conductive metal, conductive plastic or the like. The conductive material 11 may be made from one kind of conductive material, or any combination of multiple kinds of conductive materials, which is not limited in the disclosure.

In the case that the electronic device is protected by the protective case for the electronic device, if a first touch operation is performed in the second region 10b, the electronic device may receive a second touch operation corresponding to the first touch operation via the conductive material 11, and the electronic device may further execute a control instruction corresponding to the second touch operation.

During implementation, the second region 10b is made from a flexible material, or the second region 10b is flexibly connected to the first region 10a. In the case that the first touch operation is performed in the second region 10b, the first touch operation may be transferred to the conductive material 11, the corresponding second touch operation is generated on the electronic device via the conductive material 11, and the corresponding control instruction is generated. For example, in the case that the second region 10b corresponds to an answering key of the electronic device and the touch operation is performed in the second region 10b, a phone call may be answered; in the case that the second region 10b corresponds to a playing key of a music player and the touch operation is performed in the second region 10b, a music may be played or paused; and the like.

According to a preferred embodiment, the first region 10a has a thickness greater than that of the second region 10b. Therefore, the conductive material 11 is not in touch with the electronic device in the case that no external force is applied in the second region 10b.

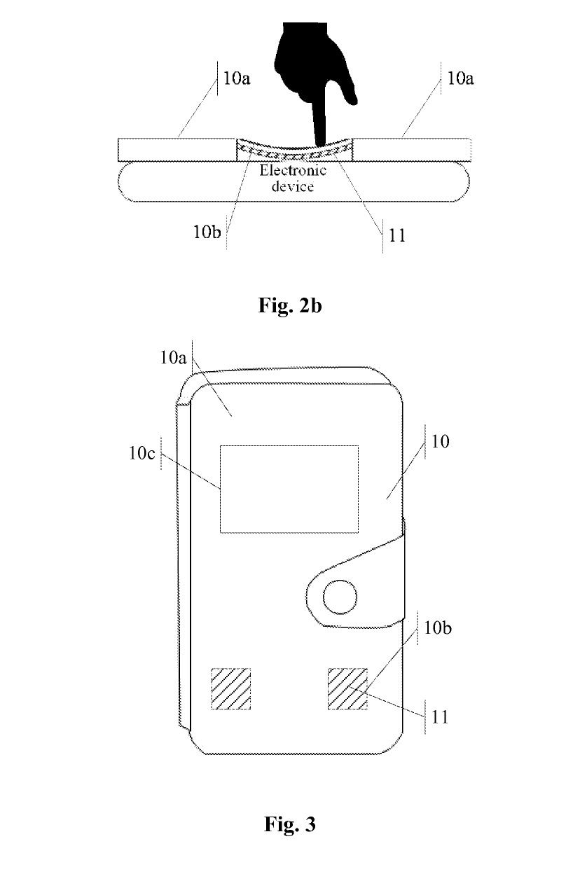

For example, the first region 10a has a first thickness of 0.3 cm, the second region 10a has a second thickness of 0.1 cm, and the conductive material 11 has a thickness of 0.5 mm; hence, the sum of the thickness of the second region and the thickness of the conductive material is less than 0.15 cm. As shown in FIG. 2a, if no touch operation is performed in the second region 10b, the conductive material is not in touch with the electronic device, and accordingly, a mis-operation may be avoided. While if the touch operation is performed in the second region 10b, as shown in FIG. 2b, the conductive material 11 is in touch with the electronic device because of a touch force corresponding to the touch operation, and accordingly, the touch operation is transferred to the electronic device. Obviously, the above values of the first thickness, the second thickness and the thickness of the conductive material are merely exemplary, and are not intended to limit the disclosure.

According to a preferred embodiment, referring to FIG. 3, the housing further includes a third region 10c different from either the first region 10a or the second region 10b. The third region 10c is made from a transparent material, and faces a display region of a display unit in the case that the electronic device is protected by the protective case for the electronic device.

In an implementation, the transparent material includes, for example, Acrylic transparent material, higher polymer transparent material, organic glass or the like, which is not limited according to the embodiment of the disclosure. Since the third region 10c faces the display region and is made from the transparent material, promoting information may be generated for the electronic device in the case that the electronic device is protected by the protective case for the electronic device. For example, in the case that a phone call is received, incoming call information may be promoted; in the case that a message is received, contents of the message may be displayed; in the case that a music is being played, music data may be displayed; and the like. In this situation, displayed content of the electronic device may be conveniently provided to a user, and accordingly the user may operate the electronic device more conveniently.

According to a preferred embodiment, a magnet is provided in the protective case for the electronic device. The electronic device may detect, through the magnet, whether the electronic device is protected by the protective case for the electronic device.

During implementation, the electronic device may be adjusted in conjunction with the protective case for the electronic device. In this situation, the electronic device needs to determine in advance that the electronic device is protected by the protective case for the electronic device. The magnet may be provided in the protective case for the electronic device, and a Hall sensor may be provided on the electronic device. In the case that the electronic device is protected by the protective case for the electronic device, a Hall current of the Hall sensor is increased due to the magnet, and accordingly, the electronic device detects that the electronic device is protected by the protective case for the electronic device.

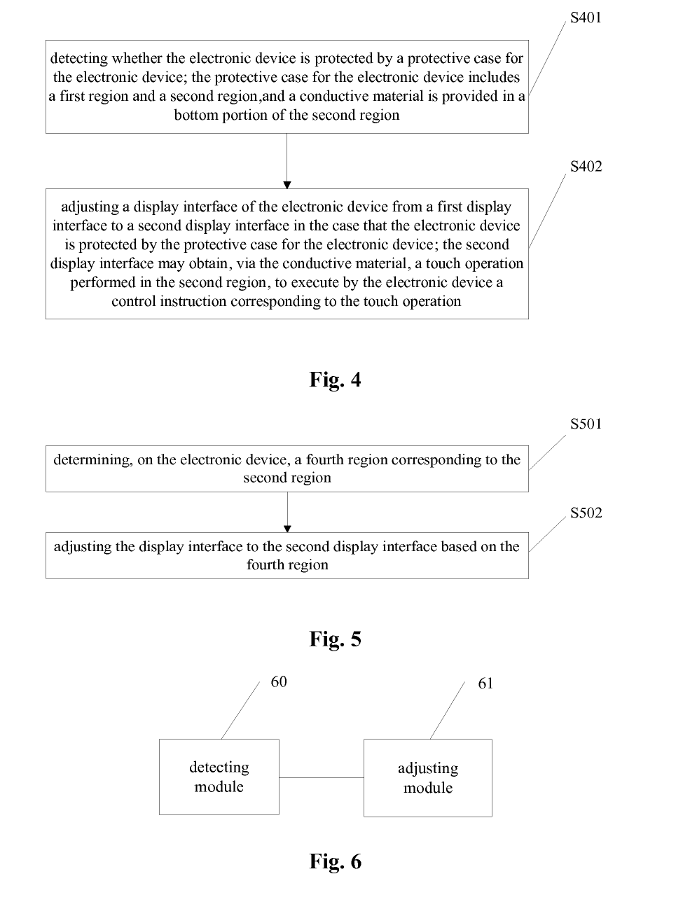

In a second aspect, an information processing method is provided according to an embodiment of the disclosure. The information processing method is applied to an electronic device such as tablet computer, mobile phone, etc. Referring to FIG. 4, the information processing method includes the following steps S401 and S402.

The step S401 is to detect whether the electronic device is protected by a protective case for the electronic device. The protective case for the electronic device includes a first region and a second region. A conductive material is provided at a bottom portion of the second region.

The step S402 is to adjust a display interface of the electronic device from a first display interface to a second display interface in the case that the electronic device is protected by the protective case for the electronic device. The second display interface may obtain, via the conductive material, a touch operation performed in the second region, to execute by the electronic device a control instruction corresponding to the touch operation.

During implementation, in the step S401, whether the electronic device is protected by the protective case for the electronic device may be detected with many approaches. Two of the approaches are described hereinafter. Obviously, it is not limited to the following two approaches during implementation.

In a first approach, in the case that a magnet is provided in the protective case for the electronic device, detecting whether the electronic device is protected by the protective case for the electronic device includes: detecting a Hall current value with a Hall sensor provided in the electronic device; determining whether the Hall current value is greater than a preset current value, and determining that the electronic device is protected by the protective case for the electronic device if the Hall current value is greater than the preset current value. Details about the detection have been described in the description about the protective case for the electronic device according to the embodiment of the disclosure, which are not further described here.

In a second approach, detecting whether the electronic device is protected by the protective case for the electronic device includes: detecting, via a proximity sensor, whether a certain region is in touch with an object, to determine whether the electronic device is protected by the protective case for the electronic device. For example, generally, when holding the electronic device, the user may hold at a middle region of the electronic device, rather than at the top of the electronic device. Hence, the proximity sensor may be provided at the top of the electronic device, and if the proximity sensor detects that the electronic device is in touch with an object, it is indicated that the electronic device is protected by the protective case for the electronic device.

During implementation, in step S402, the display interface may be adjusted from the first display interface to the second display interface with many approaches. Two of the approaches are described hereinafter. Obviously, it is not limited to the following two approaches during implementation.

In a first approach, adjusting the display interface of the electronic device from the first display interface to the second display interface includes: calling the second display interface preset in the electronic device, and replacing the first display interface with the second display interface.

During implementation, the second display interface may be preset in many ways. As an example, in the case that the electronic device is produced, a plurality of display interfaces are set in the electronic device by default, and when using the electronic device, the user may select a display interface most suitable for the protective case for the electronic device as the second display interface; as another example, the second display interface may be manually set by the user according to features of the protective case for the electronic device; and the like.

In the above solution, the second display interface is preset in the electronic device. Therefore, it is unnecessary to regenerate the second display interface, and accordingly, a technical effect of reducing the time required for switching the display interface from the first display interface to the second display interface is achieved.

In a second approach, referring FIG. 5, adjusting the display interface of the electronic device from the first display interface to the second display interface includes the following steps S501 to S502.

The step S501 is to determine, on the electronic device, a fourth region corresponding to the second region.

The step S502 is to adjust the display interface to the second display interface based on the fourth region.

In the step S501, in the case that the surface of the electronic device is protected by the protective case for the electronic device, if the conductive material is in touch with the surface of the electronic device, a current in the fourth region may vary, and accordingly, the fourth region may be determined based on the variation of the current.

In the step S502, an operation button on the display interface may be arranged in the fourth region, and it is advantageous for receiving the touch operation transferred via the conductive material of the protective case for the electronic device.

In the above solution, since the second display interface is determined based on a position of the conductive material, the generated second display interface is more accurate, and it is more advantageous for receiving a user operation.

During implementation, the second display interface may be adjusted with respect to the first display interface with many approaches. Two of the approaches are described hereinafter. Obviously, it is not limited to the following two approaches during implementation.

In a first approach, the second display interface is the display interface with the operation button facing the second region.

For example, the electronic device is a mobile phone. In the case that the protective case for the mobile phone includes two second regions respectively corresponding to left and right parts of an upper portion of the mobile phone, and the second display interface is an incoming telegram display interface of the mobile phone, an answering key may be arranged on the left part of the upper portion of the mobile phone, and a hang-up key may be arranged on the right part of the upper portion of the mobile phone. In the case that the second display interface is a music playing interface, a playing key of a player may be arranged on the left part of the upper portion of the mobile phone, and a key for playing a next music may be arranged on the right part of the upper portion of the mobile phone.

In a second approach, in the case that the protective case for the electronic device includes a third region made from a transparent material, the second display interface is the display interface with display contents facing the third region.

For example, if the second display interface is the incoming telegram display interface, incoming information may be arranged facing the third region; if the second display interface is a short message interface, the content of the short message may be arranged facing the third region; if the second display interface is the music playing interface, music information (such as content of the currently played music, lyrics, etc.) may be arranged facing the third region; and the like. In this situation, since the display contents are arranged facing the third region, it is convenient for the user to acquire information of a current electronic device, and accordingly, the touch operation received by the electronic device from the user is more accurate.

In a third aspect, an electronic device is provided according to an embodiment of the disclosure. Referring to FIG. 6, the electronic device includes a detecting module 60 and an adjusting module 61.

The detecting module 60 is configured to detect whether the electronic device is protected by a protective case for the electronic device. The protective case for the electronic device includes a first region and a second region. A conductive material is provided at a bottom portion of the second region.

The adjusting module 61 is configured to, in the case that the electronic device is protected by the protective case for the electronic device, adjust a display interface of the electronic device from a first display interface to a second display interface. The second display interface may obtain, via the conductive material, a touch operation performed in the second region, to execute by the electronic device a control instruction corresponding to the touch operation.

Optionally, in the case that a magnet is provided in the protective case for the electronic device, the detecting module 60 includes a detecting unit and a determining unit.

The detecting unit is configured to detect a Hall current value with a Hall sensor provided in the electronic device.

The determining unit is configured to determine whether the Hall current value is greater than a preset current value, and to determine that the electronic device is protected by the protective case for the electronic device if the Hall current value is greater than the preset current value.

Optionally, the adjusting module 61 is configured to:

call the second display interface preset in the electronic device, and replace the first display interface with the second display interface; or the adjusting module 61 includes:

a determining unit configured to determine, on the electronic device, a fourth region corresponding to the second region; and

an adjusting unit configured to adjust the display interface to the second display interface based on the fourth region.

Since the electronic device described according to the embodiment of the disclosure is used in the information processing method described according to the former embodiment of the disclosure, a specific structure and variations of the electronic device described according to the embodiment of the disclosure may be understood by those skilled in the art based on the described information processing method, which are not further described here.

One or more technical solutions provided in the disclosure have at least the following technical effects or advantages.

(1) According to the embodiments of the disclosure, the housing of the electronic device protective case includes the first region and the second region, and the conductive material is provided at a bottom portion of the second region. Therefore, in the case that the electronic device is protected by the protective case for the electronic device, if a touch operation is performed in the second region, the touch operation may be transferred to the electronic device via the conductive material, to execute by the electronic device the control instruction corresponding to the touch operation. That is to say, the electronic device may be operated by performing the touch operation on the protective case for the electronic device without uncovering the protective case for the electronic device. Hence, the technical effect of reducing the time required for the electronic device to receive the touch operation in the case the electronic device is protected by the protective case for the electronic device is achieved, the operation is more convenient, and accordingly, the user experience is improved.

(2) According to the embodiments of the disclosure, the first thickness of the first region is greater than the second thickness of the second region. Hence, in the case that no external force is applied in the second region, the conductive material is not in touch with the electronic device and accordingly, the mis-operation is avoided.

(3) According to the embodiments of the disclosure, the electronic device further includes the third region. The third region is made from transparent material. In the case that the electronic device is protected by the protective case for the electronic device, the third region faces the display region of the display unit. Hence, the user may view the display contents of the electronic device via the third region without uncovering the protective case for the electronic device, a technical effect of more conveniently providing the display contents of the electronic device to the user is achieved, and accordingly, it is more convenient for the user to use.

(4) According to the embodiments of the disclosure, the magnet is provided in the electronic device protective case. Hence, in the case that the Hall sensor is provided on the electronic device, a technical effect of conveniently detecting, with the Hall sensor, whether the electronic device is protected by the protective case for the electronic device is achieved.

(5) According to the embodiments of the disclosure, in the case that the electronic device is protected by the protective case for the electronic device, the display interface of the electronic device may be adjusted from the first display interface to the second display interface, the touch operation from the user may be received by the electronic device via the second display interface, and accordingly, a technical effect of operating the electronic device more conveniently is achieved.

(6) According to the embodiments of the disclosure, the Hall sensor is provided on the electronic device. Hence, a technical effect of conveniently detecting whether the electronic device is protected by the protective case for the electronic device is achieved.

(7) According to the embodiments of the disclosure, the preset second display interface may be called, and the first display interface may be adjusted to the second display interface. It is unnecessary to regenerate the second display interface, and accordingly, a technical effect of saving time is achieved.

(8) According to the embodiments of the disclosure, the second display interface may be determined based on the position of the conductive material. Hence, the generated second display interface is more accurate, and the user operation may be more convenient.

(9) According to the embodiments of the disclosure, the second display interface is the display interface with the operation button facing the second region of the protective case for the electronic device. Hence, the electronic device may control the operation button of the electronic device by responding to the operation performed in the second region, and the control for the electronic device is more accurate.

In the case that the protective case for the electronic device includes the third region made from the transparent material, the second display interface is the display interface with the display contents facing the third region. Hence, the user can read the content of the electronic device without uncovering the protective case for the electronic device, and accordingly, a technical effect of more conveniently browsing the contents of the electronic device is achieved.

It should be understood by those skilled in the art that the embodiments of the disclosure may be provided as method, system or computer program product. Therefore, the embodiments of the disclosure may be complete hardware-based, complete software-based or software-hardware combined. Furthermore, the embodiments of the disclosure may be in the form of computer program product implemented on one or more computer-available storage medium (including disc storage, CD-ROM, optical storage) having computer available program codes.

The disclosure is described in conjunction with flowcharts and/or block diagrams of the method, device (system) and computer program product according to the embodiments of the disclosure. It is to be understood that each or any combination of flows and/or blocks in the flowcharts and/or block diagrams may be implemented with computer program instructions. The computer program instructions may be supplied to a processor of general-purpose computer, dedicated computer, embedded processor or other programmable data processing devices to generate a machine, so that apparatus(es) for implementing function(s) specified in one or multiple flows in the flowcharts and/or one or multiple blocks in the block diagrams may be generated with the instructions executed by the processor of computer or other programmable data processing devices.

The computer program instructions may also be stored in a computer readable storage which can instruct the computer or other programmable data processing devices to function in specific ways so that a product including an instruction apparatus is generated with the instructions stored in the computer readable storage. The function(s) specified in one or multiple flows in the flowcharts and/or one or multiple blocks in the block diagrams is implemented with the instruction apparatus.

The computer program instructions may also loaded to the computer or other programmable data processing devices, so that a series of operation steps are performed on the computer or other programmable devices to generate computer-implemented processes. Step(s) for implementing the function(s) specified in one or multiple flows in the flowcharts and/or one or multiple blocks in the block diagrams is provided with the instructions executed on the computer or other programmable devices.

Preferred embodiments of the disclosure have been described, while alterations and modifications may be made to the embodiments by those skilled in the art based on basic creative concepts of the disclosure. Therefore, appended claims are intended to include the preferred embodiments and all the alterations and modifications falling within the scope of protection of the disclosure.

Apparently, various modifications and variations may be made by those skilled in the art without deviating from the spirit and scope of the disclosure. Therefore, if the modifications and variations fall within the scope of the claims and equivalent techniques of the disclosure, the disclosure is intended to include the modifications and variations.

1. A protective case for an electronic device, comprising:
a housing comprising a first region and a second region different from the first region, and
a conductive material provided at a bottom portion of the second region;
wherein in a case that the electronic device is protected by the protective case for the electronic device, if a first touch operation is performed in the second region, the electronic device obtains a second touch operation corresponding to the first touch operation via the conductive material, to execute a control instruction corresponding to the second touch operation.

2. The protective case for the electronic device according to claim 1, wherein the first region has a thickness greater than that of the second region, and the conductive material is not in touch with the electronic device in the case that no external force is applied in the second region.

3. The protective case for the electronic device according to claim 1, wherein the housing further comprises a third region different from either the first region or the second region, the third region is made from a transparent material, and the third region faces a display region of a display unit in the electronic device in the case that the electronic device is protected by the protective case for the electronic device.

4. The protective case for the electronic device according to claim 1, wherein a magnet is provided in the protective case for the electronic device, and the electronic device detects, through the magnet, whether the electronic device is protected by the protective case for the electronic device.

5. An information processing method applied to an electronic device, the information processing method comprising:
detecting whether an electronic device is protected by a protective case for the electronic device, wherein the protective case for the electronic device comprises a first region and a second region, and a conductive material is provided at a bottom portion of the second region; and
adjusting a display interface of the electronic device from a first display interface to a second display interface in the case that the electronic device is protected by the protective case for the electronic device, wherein the second display interface obtains, via the conductive material, a touch operation performed in the second region, to execute by the electronic device a control instruction corresponding to the touch operation.

6. The method according to claim 5, wherein in the case that a magnet is provided in the protective case for the electronic device, detecting whether the electronic device is protected by the protective case for the electronic device comprises:
detecting a Hall current value with a Hall sensor provided in the electronic device;
determining whether the Hall current value is greater than a preset current value; and
determining that the electronic device is protected by the protective case for the electronic device if the Hall current value is greater than the preset current value.

7. The method according to claim 5, wherein
adjusting the display interface of the electronic device from the first display interface to the second display interface comprises:
calling the second display interface preset in the electronic device, and replacing the first display interface with the second display interface; or
adjusting the display interface of the electronic device from the first display interface to the second display interface comprises:
determining, on the electronic device, a fourth region corresponding to the second region; and
adjusting the display interface to the second display interface based on the fourth region.

8. The method according to claim 5, wherein
the second display interface is the display interface with an operation button facing the second region; and/or
in the case that the protective case for the electronic device comprises a third region made from a transparent material, the second display interface is the display interface with display contents facing the third region.

9. The method according to claim 6, wherein
adjusting the display interface of the electronic device from the first display interface to the second display interface comprises:
calling the second display interface preset in the electronic device, and replacing the first display interface with the second display interface; or
adjusting the display interface of the electronic device from the first display interface to the second display interface comprises:
determining, on the electronic device, a fourth region corresponding to the second region; and
adjusting the display interface to the second display interface based on the fourth region.

10. The method according to claim 6, wherein
the second display interface is the display interface with an operation button facing the second region; and/or
in the case that the protective case for the electronic device comprises a third region made from a transparent material, the second display interface is the display interface with display contents facing the third region.

11. An electronic device, comprising:
a detecting module configured to detect whether the an electronic device is protected by a protective case for the electronic device, wherein the protective case for the electronic device comprises a first region and a second region, and a conductive material is provided at a bottom portion of the second region; and
an adjusting module configured to adjust a display interface of the electronic device from a first display interface into a second display interface in the case that the electronic device is protected by the protective case for the electronic device, wherein the second display interface obtains, via the conductive material, a touch operation performed in the second region, to execute by the electronic device a control instruction corresponding to the touch operation.

12. The electronic device according to claim 11, wherein in the case that a magnet is provided in the protective case for the electronic device, the detecting module comprises:
a detecting unit configured to detect a Hall current value with a Hall sensor provided in the electronic device; and
a determining unit configured to determine whether the Hall current value is greater than a preset current value, and to determine that the electronic device is protected by the protective case for the electronic device if the Hall current value is greater than the preset current value.

13. The electronic device according to claim 11, wherein
the adjusting module is configured to call the second display interface preset in the electronic device, and replace the first display interface with the second display interface; or
the adjusting module comprises:
a determining unit configured to determine, on the electronic device, a fourth region corresponding to the second region; and
an adjusting unit configured to adjust the display interface to the second display interface based on the fourth region.

14. The electronic device according to claim 11, wherein
the second display interface is the display interface with an operation button facing the second region; and/or
in the case that the protective case for the electronic device comprises a third region made from a transparent material, the second display interface is the display interface with display contents facing the third region.

15. The electronic device according to claim 12, wherein
the adjusting module is configured to call the second display interface preset in the electronic device, and replace the first display interface with the second display interface; or
the adjusting module comprises:
a determining unit configured to determine, on the electronic device, a fourth region corresponding to the second region; and
an adjusting unit configured to adjust the display interface to the second display interface based on the fourth region.

16. The electronic device according to claim 12, wherein
the second display interface is the display interface with an operation button facing the second region; and/or
in the case that the protective case for the electronic device comprises a third region made from a transparent material, the second display interface is the display interface with display contents facing the third region.
